(19) United States
(12) Patent Application Publication
(10) Pub. No.: US 2012/0293027 A1
(43) Pub. Date: Nov. 22, 2012

(54) ROTATING ELECTRICAL MACHINE AND HOUSING FOR ROTATING ELECTRICAL MACHINE

(75) Inventors: Manabu SAKURADA, Wako (JP); Tatsuya Fukushima, Wako (JP)

(73) Assignee: Honda Motor Co., Ltd., Tokyo (JP)

(21) Appl. No.: 13/450,470

(22) Filed: Apr. 19, 2012

(30) Foreign Application Priority Data
May 17, 2011 (JP) 2011-110351

(51) Int. Cl. H02K 5/22

(52) U.S. Cl. 310/89

(57) ABSTRACT

A housing for a rotating electrical machine includes a first housing block, a second housing block, a seal member, and a positioning pin. The first and second housing blocks define a breathing passage to communicate an inner space defined by the first housing block and the second housing block with an outside space of the first housing block and the second housing block. The breathing passage includes a first end hole and a second end hole. The first end hole is provided at the axial end of the first housing block. The second end hole is provided in the second housing block and faces the first end hole. The positioning pin is inserted in the first and second end holes of the breathing passage.

### CROSS-REFERENCE TO RELATED APPLICATIONS

The present application claims priority under 35 U.S.C. §119 to Japanese Patent Application No. 2011-110351, filed May 17, 2011, entitled “Housing of Rotating Electrical Machine.” The contents of this application are incorporated herein by reference in their entirety.

### BACKGROUND OF THE INVENTION

1. Field of the Invention

The present invention relates to a rotating electrical machine and a housing for the rotating electrical machine.

2. Discussion of the Background

A known rotating electrical machine which is used in a drive unit or the like of a vehicle has a rotor disposed rotatably inside an approximately annular stator. Most of rotating electrical machines of such a type have a housing accommodating a stator and a rotor and configured to include a plurality of blocks (see, for example, Japanese Unexamined Patent Application Publication No. 2009-121549).

The housing of the rotating electrical machine described in Japanese Unexamined Patent Application Publication No. 2009-121549 includes an approximately cylindrical first housing block having the stator secured to the inner peripheral surface thereof, and a second housing block separate from the first housing block and coupled to the axial-directional end thereof by a bolt or the like. Oil for lubrication or cooling is retained at the bottom of the inner space enclosed by those housing blocks. The oil retained in the inner space is supplied to individual sections in the housing by a pump which interlocks with the rotation of the rotor.

In the housing of the rotating electrical machine, a breathing passage which communicates the inner space with the outside is formed across the first housing block and the second housing block.

Specifically, a breathing hole whose one end communicates with the atmosphere is formed in the peripheral wall of the first housing block along the axial direction, and a breathing hole which has one end open to the inner space of the housing, and the other end connected to the breathing hole of the first housing block at its abutting portion to abut on the first housing block is formed in the peripheral wall of the second housing block.

When the pressure of air inside the inner space varies with the rotation of the rotor or a change in temperature, the breathing passage thus formed permits the air to flow between the inner space and the outside, thereby suppressing a variation in the pressure in the inner space.

### SUMMARY OF THE INVENTION

According to one aspect of the present invention, a housing for a rotating electrical machine includes a first housing block, a second housing block, a seal member, and a positioning pin. The first housing block has an approximately cylindrical shape. The first housing includes an inner peripheral portion in which a stator and a rotor of the rotating electrical machine are arranged. The second housing block is coupled to an axial end of the first housing block. The first and second housing blocks define a breathing passage to communicate an inner space defined by the first housing block and the second housing block with an outside space of the first housing block and the second housing block. The breathing passage includes a first end hole and a second end hole. The first end hole is provided at the axial end of the first housing block. The second end hole is provided in the second housing block and faces the first end hole. The seal member is provided between the second housing block and the axial end of the first housing block. The positioning pin has an approximately cylindrical shape and includes a through hole extending along an axial direction of the rotating electrical machine. The positioning pin is inserted in the first and second end holes of the breathing passage.

According to another aspect of the present invention, a rotating electrical machine includes a stator, a rotor, and a housing. The rotor is rotatable with respect to the stator about a rotational axis. The housing includes a first housing block, a second housing block, a seal member, and a positioning pin. The first housing block has an approximately cylindrical shape. The first housing includes an inner peripheral portion in which the stator and the rotor are arranged. The second housing block is coupled to an axial end of the first housing block. The first and second housing blocks define a breathing passage to communicate an inner space defined by the first housing block and the second housing block with an outside space of the first housing block and the second housing block. The breathing passage includes a first end hole and a second end hole. The first end hole is provided at the axial end of the first housing block. The second end hole is provided in the second housing block and faces the first end hole. The seal member is provided between the second housing block and the axial end of the first housing block. The positioning pin has an approximately cylindrical shape and includes a through hole extending along an axial direction parallel to the rotational axis. The positioning pin is inserted in the first and second end holes of the breathing passage.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a cross-sectional view corresponding to the cross section of a rotating electrical machine according to an exemplary embodiment of the disclosure along line I-I in FIG. 2.

FIG. 2 is a cross-sectional view corresponding to the cross section of the rotating electrical machine according to the exemplary embodiment of the disclosure along line II-II in FIG. 1.

FIG. 3 is an enlarged view of a portion III of the rotating electrical machine according to the exemplary embodiment of the disclosure in FIG. 1.

FIG. 4 is a cross-sectional view of a positioning pin to be used in a rotating electrical machine according to another exemplary embodiment of the disclosure.

FIG. 5 is a cross-sectional view corresponding to FIG. 3, and showing the rotating electrical machine according to the another exemplary embodiment of the disclosure.

### DESCRIPTION OF THE EMBODIMENTS

The embodiments will now be described with reference to the accompanying drawings, wherein like reference numerals designate corresponding or identical elements throughout the various drawings.

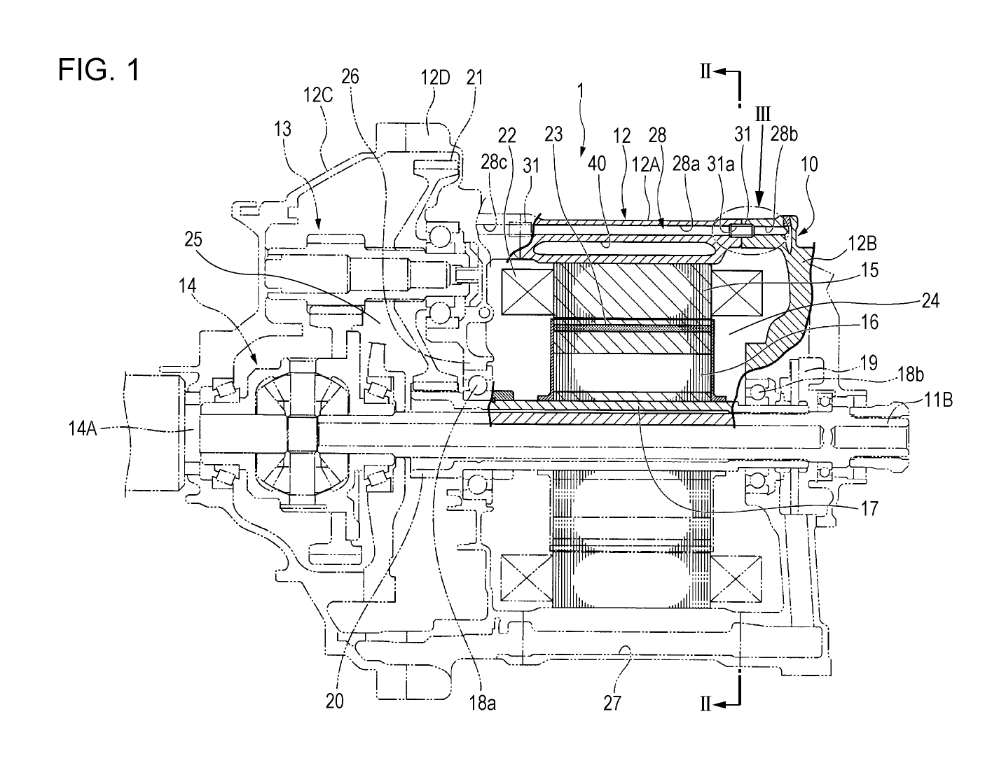

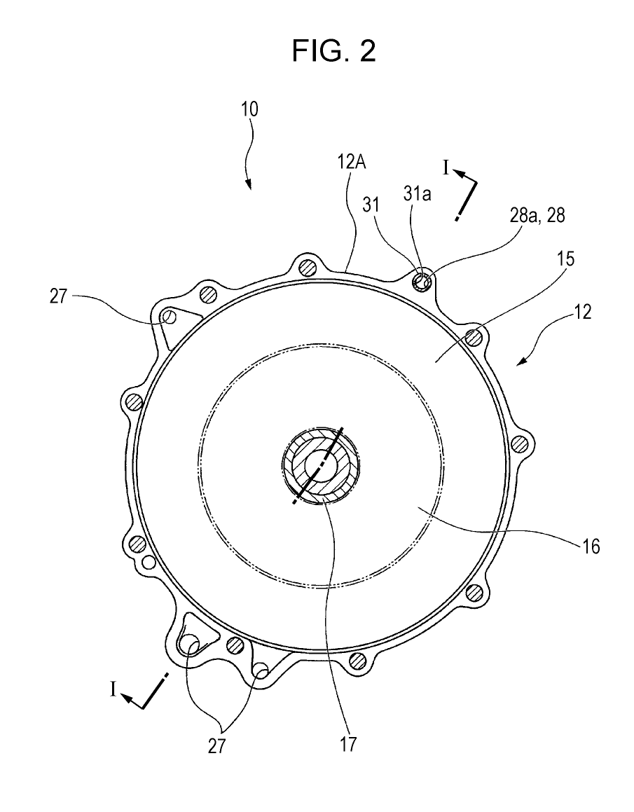

FIG. 1 is a longitudinal cross-sectional view of a drive unit 1 of a vehicle which employs a rotating electrical machine 10 according to the embodiment. FIG. 2 is a cross-sectional view corresponding to the cross section of the rotating electrical machine 10 along line II-II in FIG. 1.

Referring to FIG. 1, the vehicle has a rear left axle shaft 11A, and a rear right axle shaft 11B. A housing 12 of the drive unit 1 is provided in such a way as to cover the outer periphery of the axle shaft 11B from substantially the intermediate position between both axle shafts 11A, 11B, and is securely supported at the lower rear portion of the vehicle together with the axle shafts 11A, 11B. The rotating electrical machine 10 for driving the axle shafts, a reduction gear 13 that reduces the rotational speed of the rotating electrical machine 10, and a differential gear 14 that distributes the output of the reduction gear 13 to the left and right axle shafts 11A, 11B are accommodated to be coaxial with the axle shafts 11A, 11B in the housing 12.

The housing 12 includes a main housing block 12A enclosing the outer periphery of the rotating electrical machine 10, a side housing block 12B coupled to one axial-directional end of the main housing block 12A, a transmission housing block 12C enclosing the differential gear 14 and part of the outer periphery of the reduction gear 13, and an intermediate housing block 12D connecting the main housing block 12A to the transmission housing block 12C. According to the embodiment, the main housing block 12A constitutes the first housing block of the rotating electrical machine 10, and the side housing block 12B and the intermediate housing block 12D constitute the second housing block of the rotating electrical machine 10.

The main housing block 12A is formed approximately cylindrical, with an approximately cylindrical stator 15 securely mounted on the inner peripheral surface of the main housing block 12A. A rotor 16 is rotatably disposed inside the approximately cylindrical stator 15. The rotating electrical machine 10 according to the embodiment has an inner rotor type structure where the rotor 16 rotates inside the stator 15. In FIG. 1, a coil 22 is wound on the stator 15, and a permanent magnet 23 is secured on the outer peripheral portion of the rotor 16.

A rotor shaft 17 enclosing the outer periphery of the axle shaft 11B is coupled to the inner peripheral portion of the rotor 16. The rotor shaft 17 is rotatably supported by the housing 12 via bearings 18a, 18b so as to be coaxial with the axle shaft 11B. A resolver 19 (rotational sensor) which feeds back rotational position information of the rotor 16 to a controller (not shown) is provided between the outer peripheral portion of one axial-directional end of the rotor shaft 17 (right-hand side in FIG. 1) and the side housing block 12B. An output gear 20 is provided at the outer peripheral portion of the other axial-directional end of the rotor shaft 17 (left-hand side in FIG. 1), and is engaged with an input gear 21 of the reduction gear 13.

The intermediate housing block 12D is provided with a partition 26 to partition the interior of the housing 12 to a rotating-electrical-machine accommodating space 24 (inner space) to accommodate the rotating electrical machine 10, and a transmission accommodating space 25 to accommodate the reduction gear 13 and the differential gear 14. Oil which lubricates the sliding parts in the housing 12 and cools heat generating parts therein is stored at the bottom portions of the rotating-electrical-machine accommodating space 24 and the transmission accommodating space 25. A plurality of oil passages 27 (see FIG. 2) connect the rotating-electrical-machine accommodating space 24 to the transmission accommodating space 25.

A breathing passage 28 which communicates the upper region of the rotating-electrical-machine accommodating space 24 with the atmosphere outside the housing 12 is formed across from the side housing block 12B to the main housing block 12A and the intermediate housing block 12D.

The breathing passage 28 includes a central breathing hole 28a formed axially through the upper portion of the peripheral wall of the main housing block 12A and having a circular cross section, a breathing hole 28b of the side housing block 12B which is connected to one end of the breathing hole 28a, and a breathing hole 28c of the intermediate housing block 12D which is connected to the other end of the breathing hole 28a. The breathing hole 28b of the side housing block 12B has one end open to face the rotating-electrical-machine accommodating space 24 of the side housing block 12B, and an other end open to the abutting surface of the side housing block 12B which is abutted on the main housing block 12A. The intermediate housing block 12D has one end open to face outside the housing 12, and an other end open to the abutting surface of the side housing block 12B which is abutted on the main housing block 12A.

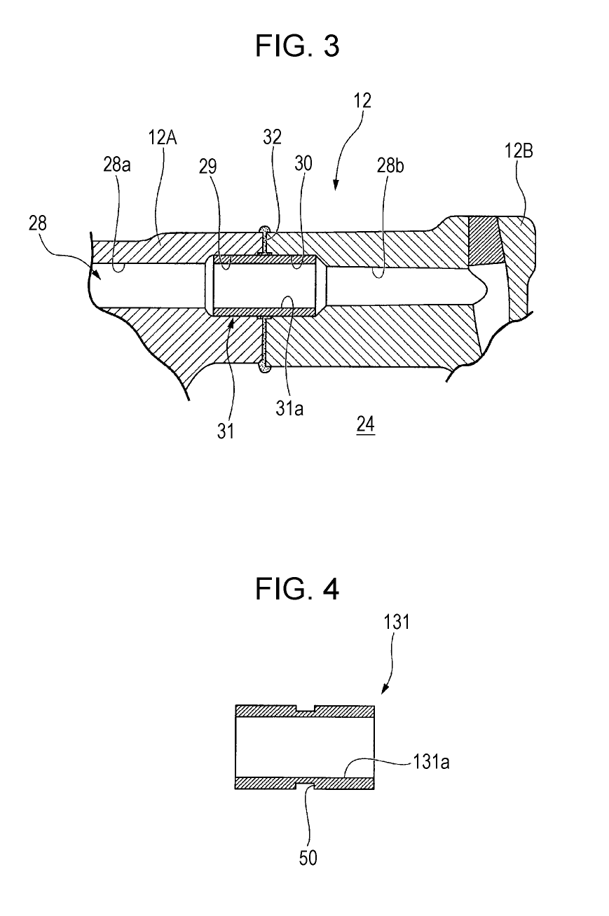

FIG. 3 is an enlarged view of a portion III in FIG. 1.

As illustrated in FIG. 3, a large-diameter portion 29 which has a larger diameter than the inside diameter of a general portion of the breathing hole 28a is provided at an end of the breathing hole 28a on that side of the main housing block 12A which is abutted on the side housing block 12B, and a large-diameter portion 30 similar to the large-diameter portion 29 is provided at an end of the breathing hole 28b on the side housing block 12B side. A positioning pin 31 is fitted across those large-diameter portions 29, 30 at the time the main housing block 12A and the side housing block 12B are fastened by bolts. The positioning pin 31 which is fitted across those large-diameter portions 29, 30 is formed cylindrical to have a through hole 31a at the axial core portion.

A seal member 32 is interposed between the abutting surfaces of the main housing block 12A and the side housing block 12B. When the main housing block 12A and the side housing block 12B are fastened by bolts, the seal member 32 tightly adheres to the abutting surfaces of the main housing block 12A and the side housing block 12B to secure the sealing between the main housing block 12A and the side housing block 12B.

Although not illustrated in detail, like the breathing hole 28a of the main housing block 12A and the breathing hole 28b of the side housing block 12B, the breathing hole 28a of the main housing block 12A and the breathing hole 28c of the intermediate housing block 12D are connected to each other by another positioning pin 31 having a through hole, and a seal member is likewise interposed between the abutting surfaces of the main housing block 12A and the intermediate housing block 12D.

Referring to FIG. 1, a coolant passage 40 is formed in the peripheral wall of the main housing block 12A to cool down the heat of the stator 15.

In the thus structured rotating electrical machine (drive unit 1), when the rotation of the stator 15 of the rotating electrical machine 10 or heat generated by the stator 15 changes the pressure in the rotating-electrical-machine accommodating space 24 in the housing 12, air flows between the rotating-electrical-machine accommodating space 24 and the outside through the breathing passage 28, thereby suppressing a variation in pressure in the rotating-electrical-machine accommodating space 24.

In the housing 12 of the rotating electrical machine (drive unit 1) according to the embodiment, the positioning pin 31 is fitted across the adjacent breathing holes 28a, 28b of the main housing block 12A and the side housing block 12B, and the positioning pin 31 is fitted across the adjacent breathing holes 28a, 28c of the main housing block 12A and the intermediate housing block 12D, so that the adjacent breathing holes 28a, 28b are connected to each other via the through holes 31a of the positioning pin 31, and the adjacent breathing holes 28a, 28c are connected to each other via the through holes 31a of the positioning pin 31. Therefore, the outer peripheral surface of the positioning pin 31 can prevent the seal member 32, interposed between the abutting surfaces of the main housing block 12A and the side housing block 12B, or interposed between the abutting surfaces of the main housing block 12A and the intermediate housing block 12D, from entering the breathing passage 28. The use of the housing 12 can make the central breathing hole 28a have a sufficiently small circular cross section while stably securing the opening area of the breathing passage 28, thus reducing the outer dimension of the peripheral wall of the main housing block 12A.

According to the housing 12 of the rotating electrical machine 10, the positioning pin 31 for positioning the main housing block 12A and the side housing block 12B, and the positioning pin 31 for positioning the main housing block 12A and the intermediate housing block 12D are used to inhibit the seal member 32 from entering the breathing passage 28. As a result, an increase in the number of components can be avoided, thus reducing the manufacturing cost accordingly.

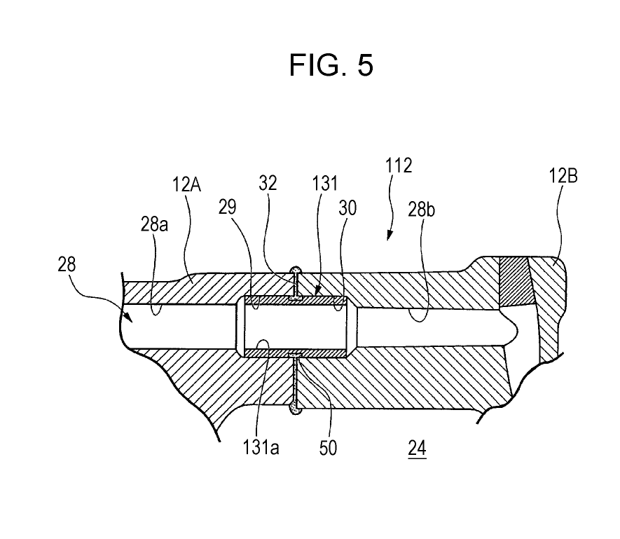

FIGS. 4 and 5 illustrate another exemplary embodiment of the disclosure. A housing 112 of a rotating electrical machine according to this embodiment differs from the foregoing embodiment only in the structure of a positioning pin 131, and is similar to the embodiment in other structures. Therefore, the following describes only the different points, and same reference numerals are given to the common portions to avoid the redundant description.

The positioning pin 131 used in the embodiment has a through hole 131a formed through the axial core portion in the axial direction, and a capturing groove 50 with an approximately square-bracket cross section formed in a substantially axial-directional center portion of its outer peripheral surface. When the positioning pin 131 is fitted in the large-diameter portions 29, 30 at the abutting surfaces of the main housing block 12A and the side housing block 12B, for example, the capturing groove 50 causes the positioning pin 131 to be positioned in a clearance between those abutting surfaces. This allows the seal member 32 interposed between the abutting surfaces of the main housing block 12A and the side housing block 12B to be captured by the capturing groove 50 in the outer peripheral surface of the positioning pin 131 as shown in FIG. 5.

According to the housing 112 of the rotating electrical machine according to the embodiment, the capturing groove 50 provided in the outer peripheral surface of the positioning pin 131 can positively capture the seal member 32. This makes it possible to cause the seal member 32 to surely run around the breathing passage 28 between the abutting surfaces of the main housing block 12A and the side housing block 12B, and between the abutting surfaces of the main housing block 12A and the intermediate housing block 12D, thereby enhancing the sealing around the breathing passage 28.

The disclosure is not limited to the foregoing embodiments, and may take various design changes without departing from the scope and spirit of the disclosure.

According to one aspect of an exemplary embodiment of the disclosure, there is provided a housing (e.g., housing 12 according to the embodiment) for a rotating electrical machine accommodating a stator (e.g., stator 15 according to the embodiment) and a rotor (e.g., rotor 16 according to the embodiment) rotating inside the stator. The housing includes a first housing block (e.g., main housing block 12A according to the embodiment) having an approximately cylindrical shape and an inner peripheral portion where the stator and the rotor are arranged, a second housing block (e.g., side housing block 12B according to the embodiment) coupled to an axial-directional end of the first housing block via a seal member (e.g., seal member 32 according to the embodiment), a breathing passage (e.g., breathing passage 28 according to the embodiment) formed across the first housing block and the second housing block for communicating an inner space (e.g., rotating-electriacal-machine accommodating space 24 according to the embodiment) enclosed by the first housing block and the second housing block with outside the first housing block and the second housing block, and a cylindrical positioning pin (e.g., positioning pin 31 according to the embodiment) having a through hole (e.g., through hole 31a according to the embodiment) along an axial direction, the positioning pin being fitted across a first-housing-block side end of the breathing passage and a second-housing-block side end of the breathing passage which are abutted against each other.

With the foregoing configuration, the first housing block and the second housing block are positioned and coupled together by the positioning pin, and the first-housing-block side end of the breathing passage and the second-housing-block side end of the breathing passage communicate with each other via the through hole of the positioning pin. Further, the seal member interposed between the first housing block and the second housing block is blocked by the peripheral wall of the positioning pin to be inhibited from entering the breathing passage. Therefore, the outer dimension of the rotating electrical machine can be reduced while stably securing the opening area of the breathing passage.

In addition, the positioning pin inhibits the seal member from enter the breathing passage, thus suppressing an increase in the number of components, which leads to reduction in manufacturing cost.

In the foregoing housing, an outer peripheral surface of the positioning pin may be provided with a capturing groove (e.g., capturing groove 50 according to the embodiment) permitting entry of the seal member interposed between the first housing block and the second housing block.

Accordingly, the seal member, which is interposed between the first housing block and the second housing block, and pushed out toward the breathing passage, is captured by the capturing groove in the outer peripheral surface of the positioning pin. This enhances the sealing around the breathing passage at the abutting portion where the first housing block and the second housing block abut on each other.

Obviously, numerous modifications and variations of the present invention are possible in light of the above teachings. It is therefore to be understood that within the scope of the appended claims, the invention may be practiced otherwise than as specifically described herein.

What is claimed is:

1. A housing for a rotating electrical machine, the housing comprising:
a first housing block having an approximately cylindrical shape, the first housing including an inner peripheral portion in which a stator and a rotor of the rotating electrical machine are arranged;
a second housing block coupled to an axial end of the first housing block, the first and second housing blocks defining a breathing passage to communicate an inner space defined by the first housing block and the second housing block with an outside space of the first housing block and the second housing block, the breathing passage including a first end hole and a second end hole, the first end hole being provided at the axial end of the first housing block, the second end hole being provided in the second housing block and facing the first end hole;
a seal member provided between the second housing block and the axial end of the first housing block; and
a positioning pin having an approximately cylindrical shape and including a through hole extending along an axial direction of the rotating electrical machine, the positioning pin being inserted in the first and second end holes of the breathing passage.

2. The housing according to claim 1, wherein an outer peripheral surface of the positioning pin is provided with a capturing groove to receive the seal member.

3. The housing according to claim 2, wherein the capturing groove is provided at a substantially same position as the seal member provided between end surfaces of the first and second housing block in the axial direction.

4. The housing according to claim 2, wherein the capturing groove has an approximately square-bracket cross section.

5. The housing according to claim 1,
wherein the breathing passage includes a first passage, a first large-diameter portion, a second passage, and a second large-diameter portion,
wherein the first passage is provided in the first housing block and is connected with the first large-diameter portion,
wherein the first large-diameter portion is provided in the first housing block and includes the first end hole, the first large-diameter portion having an inner diameter larger than an inner diameter of the first passage,
wherein the second passage is provided in the second housing block and is connected with the second large-diameter portion, and
wherein the second large-diameter portion is provided in the second housing block and includes the second end hole, the second large-diameter portion having an inner diameter larger than an inner diameter of the second passage.

6. The housing according to claim 5, wherein the positioning pin is inserted in the first and second large-diameter portions.

7. The housing according to claim 1, wherein the through hole of the positioning pin defines a part of the breathing passage.

8. The housing according to claim 1, wherein the breathing passage extends along the axial direction.

9. A rotating electrical machine comprising:
a stator;
a rotor rotatable with respect to the stator about a rotational axis;
a housing comprising:
a first housing block having an approximately cylindrical shape, the first housing including an inner peripheral portion in which the stator and the rotor are arranged;
a second housing block coupled to an axial end of the first housing block, the first and second housing blocks defining a breathing passage to communicate an inner space defined by the first housing block and the second housing block with an outside space of the first housing block and the second housing block, the breathing passage including a first end hole and a second end hole, the first end hole being provided at the axial end of the first housing block, the second end hole being provided in the second housing block and facing the first end hole;
a seal member provided between the second housing block and the axial end of the first housing block; and
a positioning pin having an approximately cylindrical shape and including a through hole extending along an axial direction parallel to the rotational axis, the positioning pin being inserted in the first and second end holes of the breathing passage.

10. The rotating electrical machine according to claim 9, wherein an outer peripheral surface of the positioning pin is provided with a capturing groove to receive the seal member.

11. The rotating electrical machine according to claim 10, wherein the capturing groove is provided at a substantially same position as the seal member provided between end surfaces of the first and second housing block in the axial direction.

12. The rotating electrical machine according to claim 10, wherein the capturing groove has an approximately square-bracket cross section.

13. The rotating electrical machine according to claim 9,
wherein the breathing passage includes a first passage, a first large-diameter portion, a second passage, and a second large-diameter portion,
wherein the first passage is provided in the first housing block and is connected with the first large-diameter portion,
wherein the first large-diameter portion is provided in the first housing block and includes the first end hole, the first large-diameter portion having an inner diameter larger than an inner diameter of the first passage,
wherein the second passage is provided in the second housing block and is connected with the second large-diameter portion, and
wherein the second large-diameter portion is provided in the second housing block and includes the second end hole, the second large-diameter portion having an inner diameter larger than an inner diameter of the second passage.

14. The rotating electrical machine according to claim 13, wherein the positioning pin is inserted in the first and second large-diameter portions.

15. The rotating electrical machine according to claim 9, wherein the through hole of the positioning pin defines a part of the breathing passage.

16. The rotating electrical machine according to claim 9, wherein the breathing passage extends along the axial direction.
